(19) United States
(12) Patent Application Publication
(10) Pub. No.: US 2009/0114633 A1
(43) Pub. Date: May 7, 2009

(54) Portable Pouch Heating Unit

(76) Inventors: David Naylor, Draper, UT (US); Kevin Day, Santa Clarita, CA (US); Thomas Caterina, Boise, ID (US)

Correspondence Address: Workman Nydegger;1000 Eagle Gate Tower, 60 East South Temple, Salt Lake City, UT, 84111, US

(21) Appl. No.: 12/260,021

(22) Filed: Oct. 28, 2008

Related U.S. Application Data
(63) Continuation-in-part of application No. 11/835,641, filed on Aug. 8, 2007.
Application No. 11/835,641 is a continuation-in-part of application No. 11/744,163, filed on May 3, 2007.
Application No. 11/744,163 is a continuation-in-part of application No. 11/218,156, filed on Sep. 1, 2005, now Pat. No. 7,230,213.
Application No. 11/218,156 is a continuation-in-part of application No. 11/422,580, filed on Jun. 6, 2006.
Application No. 11/422,580 is a continuation-in-part of application No. 11/218,156, filed on Sep. 1, 2005, now Pat. No. 7,230,213.
Application No. 11/422,580 is a continuation-in-part of application No. 11/344,830, filed on Feb. 1, 2006, now Pat. No. 7,183,524.
Application No. 11/344,830 is a continuation-in-part of application No. 11/218,156, filed on Sep. 1, 2005, now Pat. No. 7,230,213.
(60) Provisional application No. 60/688,146, filed on Jun. 6, 2005.
(60) Provisional application No. 60/654,702, filed on Feb. 17, 2005.
(60) Provisional application No. 60/656,060, filed on Feb. 23, 2005.
(60) Provisional application No. 60/688,146, filed on Jun. 6, 2005.
(60) Provisional application No. 60/654,702, filed on Feb. 17, 2005.
(60) Provisional application No. 60/656,060, filed on Feb. 23, 2005.
(60) Provisional application No. 60/688,146, filed on Jun. 6, 2005.

(51) Int. Cl. H05B 3/02; H05B 3/34; H05B 1/02

(52) U.S. Cl. 219/213; 219/528; 219/489

(57) ABSTRACT

A portable pouch for use in heating temperature sensitive materials is disclosed. The pouch includes a heating unit with one or more fasteners attached around its outer edges. The heating unit can be folded to allow the one or more fasteners to secure opposing outer edges of the heating unit together to form a pocket for substantially enclosing the materials to be warmed. The heating unit can be electrically connected to a direct current power source. The heating unit includes first and second cover layers enclosing a heat generating element and a carbon-based heat spreading element. A thermal insulation layer is also positioned between the first and the second cover layers. The heating element is adapted to generate and evenly spread heat over the interior surface of the pocket to evenly heat the materials disposed within the pocket.

### CROSS-REFERENCE TO RELATED APPLICATIONS

This application is a continuation in part of co-pending U.S. application Ser. No. 11/835,641 filed on Aug. 8, 2007 titled GROUNDED MODULAR HEATED COVER, which is a continuation in part of U.S. patent application Ser. No. 11/744,163 filed May 3, 2007, which is a continuation in part of U.S. patent application Ser. No. 11/218,156 filed Sep. 1, 2005, now U.S. Pat. No. 7,230,213, issued on June 12, 2007. This application is also a continuation in part of co-pending U.S. application Ser. No. 11/422,580 filed on Jun. 6, 2006, titled “A RADIANT HEATING APPARATUS” which claims priority to U.S. Provisional Patent Application 60/688,146 filed Jun. 6, 2005, titled LAMINATE HEATING APPARATUS. U.S. application Ser. No. 11/422,580 filed on Jun. 6, 2006, titled “A RADIANT HEATING APPARATUS” is a Continuation in Part of U.S. patent application Ser. No. 11/218,156, filed Sep. 1, 2005, now U.S. Pat. No. 7,230,213 issued on Jun. 12, 2007, which claims priority to: U.S. Provisional Patent Application 60/654,702 filed on Feb. 17, 2005, titled A MODULAR ACTIVELY HEATED THERMAL COVER; U.S. Provisional Patent Application 60/656,060 filed Feb. 23, 2005 titled A MODULAR ACTIVELY w m ; HEATED THERMAL COVER; and U.S. Provisional Patent Application 60/688,146 filed Jun. 6, 2005, titled LAMINATE HEATING APPARATUS. U.S. application Ser. No. 11/422,580 filed on Jun. 6, 2006, titled “A RADIANT HEATING APPARATUS” is also a Continuation in Part of U.S. patent application Ser. No. 11,344,830, filed Feb. 1, 2006 now U.S. Pat. No. 7,183,524 issued on Feb. 27, 2007, which claims priority to: U.S. Provisional Patent Application 60/654,702 filed on Feb. 17, 2005, titled A MODULAR ACTIVELY HEATED THERMAL COVER; U.S. Provisional Patent Application 60/656,060 filed Feb. 23, 2005 titled A MODULAR ACTIVELY HEATED THERMAL COVER; and U.S. Provisional Patent Application 60/688,146 filed Jun. 6, 2005, titled LAMINATE HEATING APPARATUS. U.S. patent application Ser. No. 11,344,830, filed Feb. 1, 2006 now U.S. Pat. No. 7,183,524 issued on Feb. 27, 2007, is also a Continuation in Part of U.S. patent application Ser. No. 11/218,156, filed Sep. 1, 2005, now U.S. Pat. No. 7,230,213 issued on Jun. 12, 2007. Each of the preceding U.S. patent applications and patents is incorporated herein in its entirety by this reference.

### BACKGROUND

1. Background and Relevant Art

Changing weather can affect driving surfaces. For example, the expansion and contraction of asphalt paved surfaces during winter months caused by the cycling of the temperature of the asphalt paved surfaces due to alternating exposure to sun and snow can cause potholes in the asphalt driving surfaces. To fix these potholes, asphalt patch is used, which is a combination of oil, gravel, tar, and a number of other materials. To use the asphalt patch, the asphalt patch needs to be maintained above a given temperature to allow it to be properly applied to a pothole. However, cold weather conditions can make maintaining the asphalt patch above the given temperature a challenge. Cities and other municipalities often discard as much as 40% of asphalt patch purchased, because it cannot be maintained at an appropriate temperature

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein is directed to a portable pouch for use in providing evenly distributed heat to temperature sensitive materials. The portable pouch includes a heating unit that has one or more fasteners attached around its outer edges. The heating unit can be folded to enable the one or more fasteners to secure together opposing outer edges of the heating unit, thereby forming a substantially enclosed pocket for receiving materials to be warmed. In one embodiment, the pocket formed by the heating unit is sized to receive one or more bags of asphalt patch. The heating unit can be adapted for electrical connection to a direct current power source, such as an automotive power source.

In some exemplary embodiments, the heating unit includes first and second cover layers and an electrical heating element disposed therebetween. The electrical heating element is configured to convert electrical energy from the direct current source to heat energy and to distribute the heat energy over a surface of the heating unit. In one embodiment, the electrical heating element includes a heat generating element for converting electrical current to heat energy and a carbon-based heat spreading element thermally coupled to the heat generating element for evenly distributing the heat energy over the surface of the heating unit. The heating unit can also include a thermal insulation layer positioned adjacent the electrical heating element between the first and the second cover layers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more filly apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an exemplary embodiment of a heating unit according to the present invention;

FIG. 2 illustrates a partially exploded view of the heating unit of FIG. 1;

FIG. 3 illustrates an exploded view of some of the components of the heating unit of FIG. 1 showing the construction of the heating unit with adhesive layers;

FIG. 4 illustrates details of a heat spreading element of the heating unit of FIG. 1;

FIGS. 5A and 5B illustrate comparative alternate temperature arrangements for the heating unit of FIG. 1; and

FIGS. 6A through 6C illustrate one method of covering or enclosing objects with the heating unit of FIG. 1.

### DETAILED DESCRIPTION

Disclosed herein are embodiments of a heating unit for use in asphalt patch or other warming applications. In particular, embodiments may include a heating unit configured to substantially cover or enclose the entire outer surface of one or more bags, packages, or containers of asphalt patch. While the heating unit of the present invention is described as being used to heat bags, packages, or containers of asphalt patch, it will be appreciated that the heating unit may also be used to provide heat to other objects and materials.

Embodiments of the heating unit disclosed herein can be used in direct current applications, such as automotive or other applications using direct current power supplies. Illustrated embodiments include details related to direct current (DC) embodiments, and in particular, some embodiments are particularly suited for 12V DC automotive embodiments. This allows for the heating unit to be used in a number of unique and novel ways. For example, while many heaters have required that the heater be located near a distributed power source, such as a power source receiving power directly from power company generators, embodiments herein allow the heating unit to be implemented in a fashion that allows them to be used without the availability of direct power company distributed power, but rather by other types of power sources, such as a vehicle's 12 Volt battery or alternator supplied power. Thus, embodiments may be implemented where heat is supplied while a heating unit is located remotely from a power company supplied power source. Other uses will also be discussed below. For example, embodiments may be implemented with portable batteries or other power sources.

Additionally, heating may be supplied in mobile environments. For example, in cold environments, a heating unit may be connected electrically to an automobile's power source, such as by hard wiring, connection through a cigarette lighter plug or utility plug, or connection via a clip to battery terminals, etc., such that heat can be provided while the automobile is in motion.

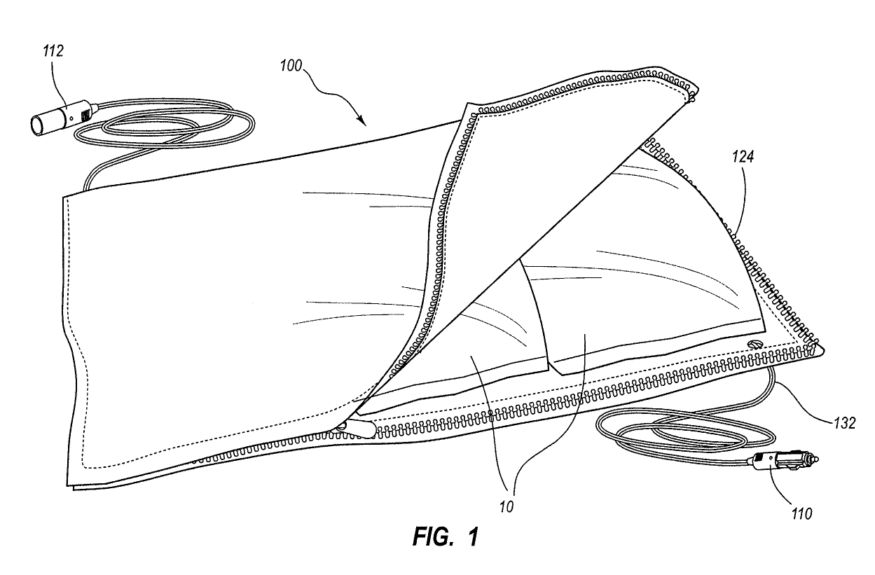

The heating unit can include a heating element which provides heat and spreads the heat over at least a portion of the surface of the heating unit. The heating unit may also include an insulation layer to prevent heat from being lost to an environment external to the heating unit or its contents. For example, FIG. 1 illustrates one embodiment of a heating unit configured as a portable pouch heating unit 100 covering or enclosing multiple bags of asphalt patch 10. While FIG. 1 illustrates the heating unit as a portable pouch heating unit for heating bags of asphalt patch, it will be appreciated that the heating unit can be sized, shaped, or otherwise configured to provide heat to other types of objects or materials.

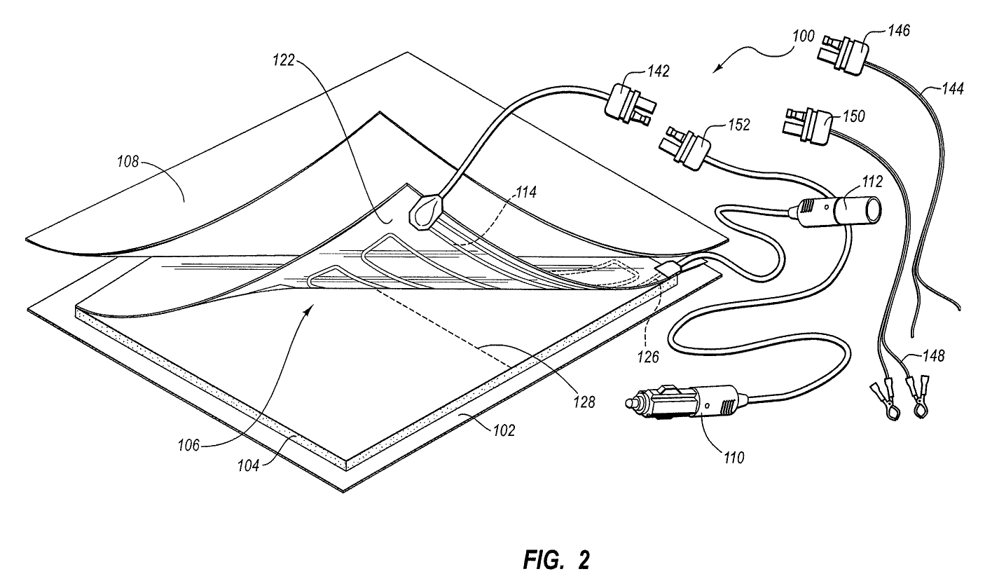

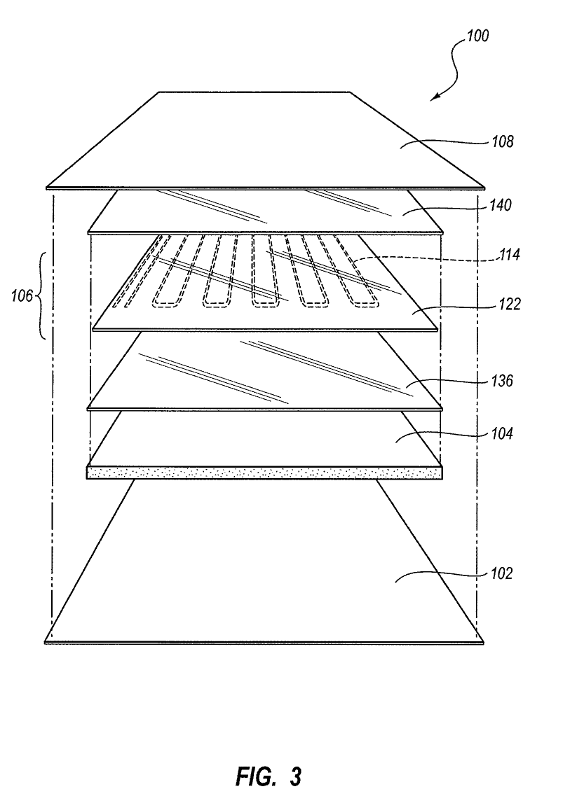

An example of components implemented in one embodiment is illustrated in FIGS. 2 and 3. These Figures illustrate the construction of the heating unit, including materials used to assemble the heating unit. FIG. 2 illustrates a partially exploded view illustrating the flexible nature of a heating unit 100 that includes a first cover layer 102, an insulation layer 104, a heating element 106, and a second cover layer 108. In some embodiments, the heating element 106 includes a heat generating strip 114 and a heat spreading element 122, each of which will be described in greater detail below. The heating unit 100 further includes an incoming direct current electrical connector 110. The heating unit can also include an outgoing direct current electrical connector 112. While the example illustrated in FIG. 2 is illustrated as partially exploded, some finished embodiments may be manufactured such that the insulation layer 104 and the heating element 106 may be sealed between the first cover layer 102 and the second cover layer 108. Sealing processes and details will be discussed in more detail below.

FIG. 3 illustrates a fully exploded view of the heating unit 100 so as to more clearly illustrate the individual components of the heating unit 100. As illustrated in FIG. 3, first and second cover layers 102 and 108 are generally planar sheets of material that are disposed on opposing sides of the internal components of heating unit 100. During construction of heating unit 100, first cover layer 102 is positioned as illustrated in FIG. 3. Next, insulation layer 104 is positioned on top of first cover layer 102 and heating element 106 is then positioned on top of insulation layer 104. Finally, second cover layer 108 is positioned on top of heating element 106. With the various components of heating unit 100 so positioned, the peripheral edges of first and second layers 102 and 108 can be joined, sealed, or otherwise closed.

Heating unit 100, constructed as described herein, can be used in numerous applications that require heat to be transferred to an object or surface. As described herein, the various components of heating unit 100 are flexible such that heating unit 100 can be wrapped around objects, laid on top, beneath, or hung adjacent objects or surfaces, and rolled or folded up when not in use. In order to ensure that heating unit 100 and its various components retain their shape and their positions relative to one another, the various components of heating unit 100 can be attached to one another. For example, the various components of heating unit 100 can be glued, bonded, or otherwise held together. Attaching the components of heating unit 100 together helps to prevent the components from moving relative to one another within heating unit 100.

For example, attaching heating element 106 to insulation layer 104 ensures that heating element 106 will stay positioned next to insulation layer 104 and will not sag, bunch, or otherwise move within heating unit 100. In particular, because insulation layer 104 is formed of a stiffer material than heating element 106, attaching heating element 106 to insulation layer 104 provides stiffness to heating element 106. While insulation layer 104 is referred to as being formed of a “stiffer” material, it will be appreciated that in some embodiments insulation layer 104 may still be flexible such that it can be wrapped or folded around an object, such as a bag of asphalt patch, for example.

Similarly, heat generating strip 114 and heat spreading element 122 can be attached to one another to ensure that heat generating strip 114 is properly positioned on heat spreading element 122, even after heating unit 100 is rolled, folded, and used several times. Likewise, heating element 106 and/or insulation layer 104 can be attached to first and/or second cover layers 102 and 108 to prevent the internal components of heating unit 100 from moving within first and second cover layers 102 and 108.

FIG. 3 illustrates one exemplary embodiment in which various components of heating unit 100 can be attached together. For convenience of illustration, incoming electrical connector 110 and outgoing electrical connector 112 are omitted from FIG. 3. In the embodiment illustrated in FIG. 3, there are two interfaces between the heating unit components for attachment between the components. As used herein, an attachment interface is a surface where two or more components of heating unit 100 are attached together. The first attachment interface 136 is between the top surface of insulation layer 104 and the bottom surface of heating element 106. As noted herein, heating element 106 includes a heat generating strip 114 mounted on a heat spreading element 122. In the illustrated embodiment, the heat generating strip 114 is mounted on the bottom surface of heat spreading element 122 such that heat generating strip 114 is positioned between heating spreading element 122 and insulation layer 104. Attachment interface 136 is therefore between the top surface of insulation layer 104 and the bottom surface of heat spreading element 122, with heat generating element 114 mounted on heat spreading element 122 therebetween.

The second attachment interface 140 is between the top surface of heat spreading element 122 and the bottom surface of second cover layer 108. In other embodiments, there is only the first attachment interface 136. Still in other embodiments, there are additional attachment interfaces, such as between the bottom surface of insulation layer 104 and the top surface of first cover layer 102.

Attachment interfaces 136 and 140 can be created by attaching the above identified components of heating unit 100 in any suitable manner so that the components maintain their relative positions one to another. In one exemplary embodiment, attachment interfaces 136 and 140 are created using an adhesive between the components of heating unit 100. One adhesive suitable for attaching together the id z components of heating unit 100 is 30-NF FASTBOND™ available from 3M located in St. Paul, Minn. FASTBOND™ is a non-flammable, heat resistant, polychloroprene base adhesive.

In order to properly adhere the components of heating unit 100 together with FASTBOND™, the interfacing surfaces should be clean and dry. With the surfaces prepared, a uniform coat of FASTBOND™ is applied to both interfacing surfaces. After applying, the FASTBOND™ is allowed to dry completely, which typically takes about 30 minutes. Once the FASTBOND™ on both surfaces is dry, the two FASTBOND™ coated surfaces are joined together.

For example, when attaching insulation layer 104 to heat spreading element 122, a coat of FASTBOND™ is applied to the top surface of insulation layer 104 and the bottom surface of heat spreading element 122 over the top of heat generating strip 114. Once the FASTBOND™ on each surface is dry, heat spreading element 122 is positioned on top of insulation layer 104 and the two layers of FASTBOND™ adhere to one another. The same process can be followed to attach second cover layer 108 to the top surface of heat spreading element 122 or to attach the first cover layer 102 to the bottom surface of insulation layer 104.

In the illustrated embodiment, second cover layer 108 is attached to heating element 106 and heating element 106 is attached to insulation layer 104. Notably, however, insulation layer 104 and heating element 106 can be left unattached from first and/or second cover layers 102 and 108. Not attaching insulation layer 104 and heating element 106 to first and/or second cover layers 102 and 108 can provide for flexibility and give in heating unit 100 when heating unit 100 is folded, rolled, or wrapped around an object. Specifically, heating unit 100 is configured to be wrapped around an object such that second cover layer 108 is adjacent the object and first cover layer 102 is positioned away from the object (see FIG. 1 in which first cover layer 102 is showing on the outside of heating unit 100). When first and/or second cover layers 102 and 108 are not attached to insulation layer 104 and/or heating element 106, first and/or second cover layers 102 and 108 are able to move relative to insulation layer 104 and heating element 106 and stretch as heating unit 100 is wrapped around an object. In other embodiments, however, insulation layer 104 and first cover layer 102 are attached to one another while heating element 106 and second cover layer 108 are attached to one another. It will be appreciated, however, that heating unit 100 can be flexible enough to wrap around an object even when the first and/or second cover layers 102 and 108 are attached to insulation layer 104 and/or heating element 106.

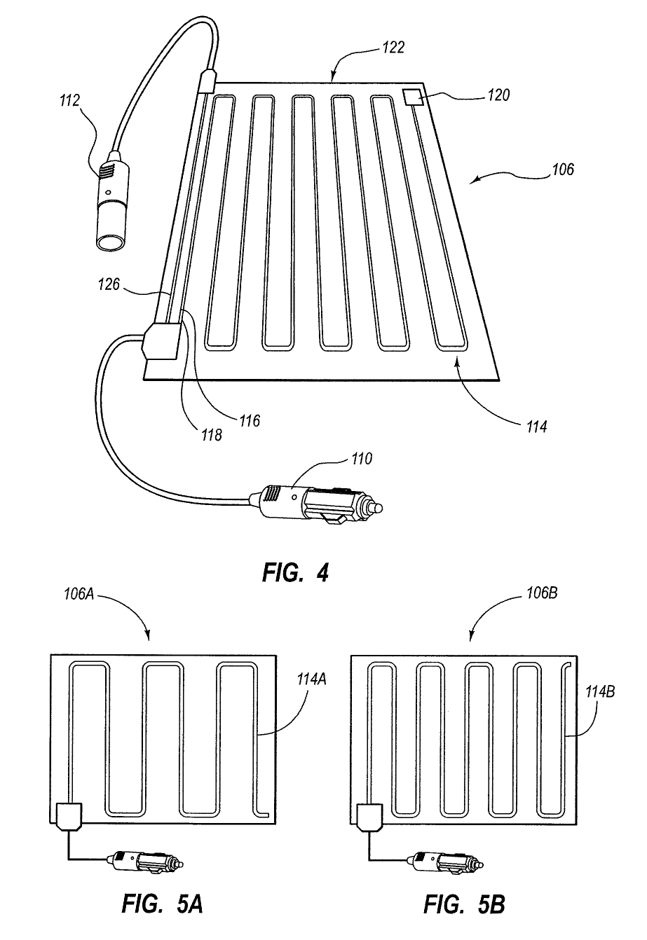

The following discussion will now treat additional details and embodiments of the various components of the heating unit 100. Referring now to FIG. 4 and as noted above, in some embodiments the heating element 106 includes a heat generating strip 114. The heat generating strip 114 may be, for example, an electro-thermal coupling material or resistive element. In some embodiments, the heat generating strip may be a copper, copper alloy, or other conductor. In one embodiment, the conductor is a network of copper alloy elements configured to generate about 9 W of power per linear foot of the heat generating strip. This may be achieved by selection of appropriate alloys for the heat generating element 114 in combination with selection of appropriate heat generating element wire sizes and circuit configurations. The conductor may convert electrical energy to heat energy, and transfer the heat energy to the surrounding environment. Alternatively, the heat generating element 114 may comprise another conductor, such as semiconductors, ceramic conductors, other composite conductors, etc., capable of converting electrical energy to heat energy. The heat generating strip 114 may include one or more layers for electrical insulation, temperature regulation, and ruggedization.

Notably, other heat sources may be used in addition to or as alternatives to the heat generating strip. For example, some embodiments may include the use of exothermic chemical reactions to generate heat or heating tubes which a heated liquid runs through.

With continuing reference to FIG. 4, the heat generating strip 114 is illustrated with two heat generating conductors 116 and 118. One of the two conductors can be connected to a positive terminal of the incoming direct current electrical connection 110 while the other conductor can be connected to a negative terminal of the direct current electrical connection 110. The two conductors 116 and 118 may be connected at one end to create a closed circuit allowing current to flow through the two conductors to generate heat. The first and second terminals may be connected to electrical sources as appropriate, such as generator supplied AC or DC sources, batteries, power inverters, etc.

In the example illustrated in FIG. 4, the two conductors are connected through a thermostat 120. In this example, the thermostat 120 includes a bi-metal strip based temperature control that disconnects the two conductors 116 and 118 at a pre-determined temperature. Examples of such predetermined temperatures may be 70° F., 90° F., 100° F., and 130° F. Notably, these are only examples, and other temperatures may be alternatively used. This can be used to regulate the temperature of the heating unit 100 to prevent overheating, or to maintain the temperature at a temperature of about the pre-determined temperature.

Embodiments may be implemented where the temperature is determined by selecting a thermostat 120 with a fixed temperature rating. Other embodiment may be implemented where the temperature setting of the thermostat can be adjusted to a predetermined temperature at manufacturing time. In some embodiments, the thermostat may be user accessible to allow a user to adjust the thermostat settings. While in the example illustrated the thermostat is located at the ends of the conductors 116 and 118, it should be appreciated that in other embodiments the thermostat may be placed inline with one of the conductors 116 and 118. Additionally, some embodiments may include low voltage control circuitry including temperature control functionality, which controls application of power to the conductors 116 and 118 to regulate temperature.

It should further be appreciated that embodiments may be implemented where other temperature or current protections are included. For example, embodiments may include magnetic and/or thermal circuit breakers, fuses, semiconductor based over-current protection, ground fault protection, arc fault protection, etc. In some embodiments, these may be located at the ends of the conductors 116 and 118 or inline with one or more of the conductors 116 and 118, as appropriate.

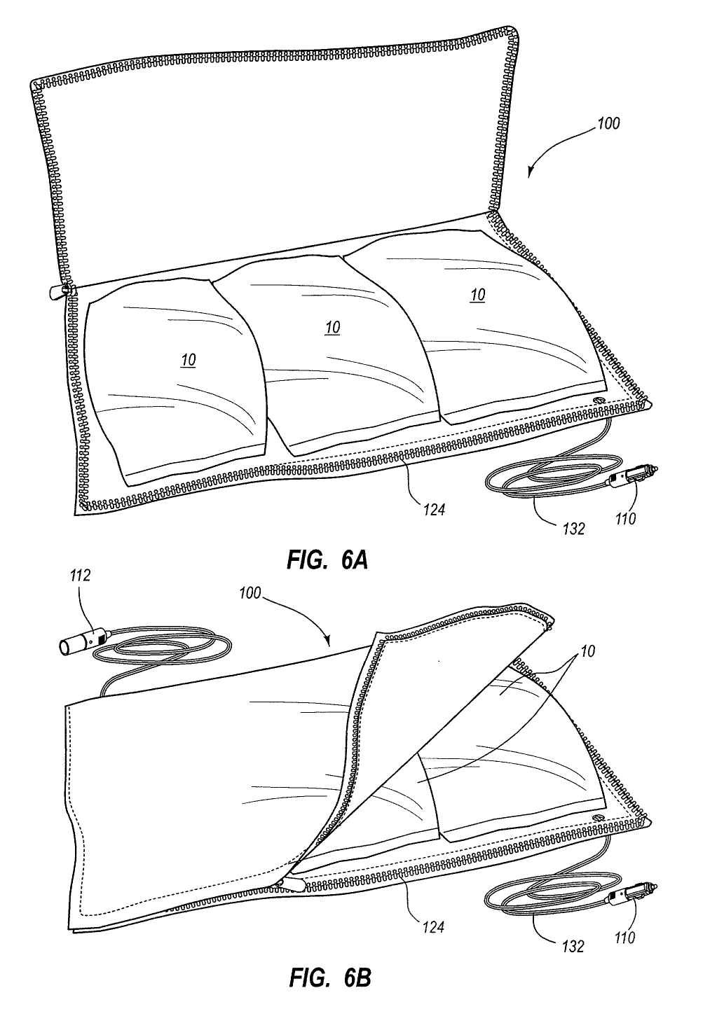

Additionally, controlling temperature may be accomplished by controlling the density of the heat generating element 114. This may be accomplished by controlling spacing between different portions of the heat generating element allowing for more or less material used for the heat generating element 114 to be included in the heating unit 100. This method may be especially useful when heat generating elements have a constant Wattage output per length of heat generating element. Thus a longer heat generating element 114 provides more heat than a shorter heat generating element 114. FIGS. 5A and 5B illustrate a comparative example where two alternative embodiments are illustrated. Each of the embodiments illustrates a heating unit 100 of the same size, but with different heat generating elements densities. The first embodiment illustrates a heating element 106A with a less dense heat generating element 114A, while the second embodiment illustrates a heating element 106B with a more dense heat generating element 114B.

Notably, the temperature may also be controlled by selection of the heat generating element 114 properties. For example, while the example above illustrates a heat generating element 114 that produces 9 Watts per linear foot, other heat generating elements may produce more heat if higher temperatures are desired or less heat if lower temperatures are desired.

By way of the method described herein, the temperature of one or more bags of asphalt patch 10 can be regulated. In particular, by way of a thermostat or the selection and configuration of the heating unit components, the temperature of the asphalt patch can be maintained at a desired temperature or within a desired temperature range. Thus, the thermostats, configuration of the heating unit components, and the temperature protection mechanisms described herein enable a portable pouch heating unit 100 to be maintained at a desired temperature or within a desired temperature range. By way of example, some desired temperatures ranges may include 50-130° F., 70-100° F., and 75-90° F. Notably, these are only examples, and other temperature ranges may be alternatively used.

Returning attention to FIG. 4, as noted above, the electrical heating element 106 may further include a heat spreading element. In general terms, the heat spreading element 122 is a layer of material capable of drawing heat from the heat generating element 114 and distributing the heat energy away from the heat generating element 114. Specifically, the heat spreading element 122 may comprise a metallic foil, wire mesh, carbon mesh, graphite, a composite material, or other material.

The heat-spreading element 122 in one embodiment is an electrically-conductive material comprising carbon. Graphite is one example of an electrically-conductive material comprising carbon. However, other suitable materials may include carbon-based powders, carbon fiber structures, or carbon composites. Those of skill in the art will recognize that material comprising carbon may further comprise other elements, whether they represent impurities or additives to provide the material with particular additional features. Materials comprising carbon may be suitable so long as they have sufficient thermal conductivity to act as a heat-spreading element. The heat-spreading element 122 may further comprise a carbon derivative, or a carbon allotrope.

One example of a material suitable for a heat spreading element 122 is a graphite-epoxy composite. The in-plane thermal conductivity of a graphite-epoxy composite material is approximately 370 watts per meter per Kelvin, while the out of plane thermal conductivity of the same material is 6.5 watts per meter per Kelvin. The thermal anisotropy of the graphite/epoxy composite material is then 57, meaning that heat is conducted 57 times more readily in the plane of the material than through the thickness of the material. This thermal anisotropy allows the heat to be readily spread out from the surface which in turn allows for more heat to be drawn out of the heating element 114.

The heat spreading element 122 may comprise a material that is thermally isotropic in one plane. The thermally isotropic material may distribute the heat energy more evenly and more efficiently. One such material suitable for forming the heat spreading element 122 is GRAFOIL® available from Graftech Inc. located in Lakewood, Ohio. In particular, GRAFOIL® is a flexible graphite sheet material made by taking particulate graphite flake and processing it through an intercalculation process using mineral acids. The flake is heated to volatilize the acids and expand the flake to many times its original size. The result is a sheet material that typically exceeds 98% carbon by weight. The sheets are flexible, lightweight, compressibly resilient, chemically inert, fire safe, and stable under load and temperature. The sheet material typically includes one or more laminate sheets that provide structural integrity for the graphite sheet.

Due to its crystalline structure, GRAFOIL® is significantly more thermally conductive in the plane of the sheet than through the plane of the sheet. This superior thermal conductivity in the plane of the sheet allows temperatures to quickly reach equilibrium across the breadth of the sheet.

Typically, the GRAFOIL® will have no binder, resulting in a very low density, making the heated cover relatively light while maintaining the desired thermal conductivity properties. For example, the standard density of GRAFOIL® is about 1.12 g/ml. It has been shown that three stacked sheets of 0.030″ thick GRAFOIL® have similar thermal coupling performance to a 0.035″ sheet of cold rolled steel, while weighing about 60% less than the cold rolled steel sheet.

Another product produced by GrafTech Inc. that is suitable for use as a heat spreading element 122 is EGRAF® SPREADERSHIELD™. The thermal conductivity of the SPREADERSHIELD™ products ranges from 260 to 500 watts per meter per Kelvin within the plane of the material, and the out of plane (through thickness) thermal conductivity ranges from 6.2 down to 2.7 watts per meter per Kelvin. The thermal anisotropy of the material ranges from 42 to 163. Consequently, a thermally anisotropic planar heat spreading element 122 serves as a conduit for the heat within the plane of the heat spreading element 122, and quickly distributes the heat more evenly over a greater surface area than a foil. The efficient planar heat spreading ability of the planar heat spreading element 122 also provides for a higher electrical efficiency. In some embodiments, the heat spreading element 122 is a planar thermal conductor. In certain embodiments, the graphite may be between 1 thousandth of an inch thick and 40 thousandths of an inch thick. This range may be used because within this thickness range the graphite remains pliable and durable enough to withstand repeated rolling and unrolling as the heating unit 100 is unrolled for use and rolled up for storage.

The heat spreading element 122 may comprise a flexible thermal conductor. In certain embodiments, the heat spreading element 122 is formed in strips along the length of the heat generating element 114. In alternative embodiments, the heat spreading element 122 may comprise a contiguous layer.

In some embodiments, the heat spreading element 122 may also include functionality for conducting electrical energy and converting electric energy to thermal energy in a substantially consistent manner throughout the heat spreading element. Graphite heat spreading elements may be particularly well suited for these embodiments. In such an embodiment, a heat generating element 114 may be omitted from the heating unit 100 as the heat spreading element 122 serves the purposes of conveying current, producing heat due to resistance, and evenly distributing the heat.

The small size and thickness of the graphite minimizes the weight of the heat spreading element 122. The graphite containing heat spreading element may be pliable such that the graphite can be rolled lengthwise without breaking the electrical path through the graphite.

In some embodiments, the heat spreading element 122 may include an insulating element formed of a thin plastic layer on both sides of the heat-spreading element 122. The insulating element may additionally provide structure to the heat-spreading material used in the heat spreading element 122. For example, the insulating element may be polyethylene terephthalate (PET) in the form of a thin plastic layer applied to both sides of heat-spreading element 122 comprising graphite. Those of skill in the art will appreciate that such a configuration may result in the insulating element lending additional durability to the heat-spreading element 122 in addition to providing electrical insulation, such as electrical insulation from the electrical current in the heat generating element 114. It should be noted that the heat generating element 114 may include its own electrical insulation as well as described above.

In some embodiments, the heat spreading element 122 may include a heat conducting liquid such as water, oil, grease, etc.

In certain embodiments, the heat generating element 114 is in direct contact with the heat spreading element 122 to ensure efficient thermo-coupling. Alternatively, the heat spreading element 122 and the heat generating element 114 are integrally formed. For example, the heat spreading element 122 may be formed or molded around the heat generating element 114. Alternatively, heat generating strip 114 and the heat spreading element 122 may be adhesively coupled as described herein.

Notably, while temperature may be controlled with the use of thermostats as described above, other embodiments may implement other design criteria to control temperature. For example, some embodiments may use appropriate selection of the heat spreading element 122 and/or the arrangement of the heat generating element 114. Illustratively, the heat retention properties of the heat spreading element 122 may be a factor in regulating temperatures at which a heating unit 100 will operate. Further, the density of the heat generating element 114 with respect to the size of the heating unit 100 or the heat spreading element 122 can be used set the operating temperatures or to regulate temperatures, as described herein.

In some embodiments, the heating unit can be sized to substantially enclose objects, such as one or more bags of asphalt patch, of various sizes. In one exemplary embodiment, the heating unit is approximately six (6) fee long and four (4) feet wide so that when the heating unit is folded closed as described below, the heating unit is approximately three (3) feet by four (4) feet. In another exemplary embodiment, the heating unit is approximately twelve (12) feet long and four and one-half (4.5) feet wide when open and six (6) feet by four (4.5) feet when closed. In yet another embodiment, the heating unit is approximately six (6) feet long and three (3) feet wide when open and three (3) feet by three (3) feet when closed. It will be appreciated, however, that the heating unit can be sized and configured to substantially enclose objects and materials of any size or shape.

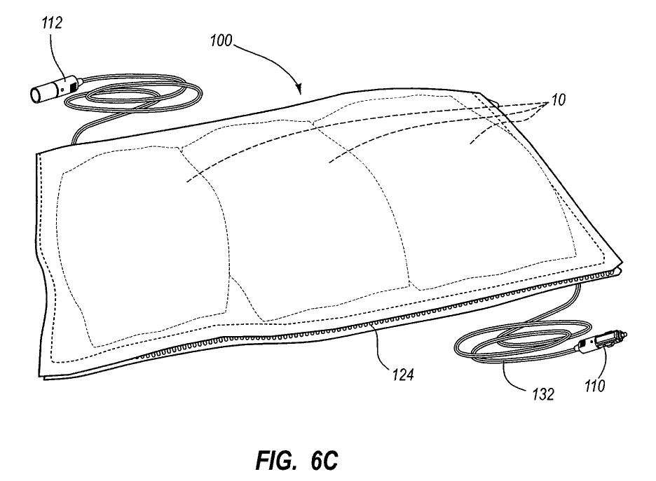

Returning once again to FIGS. 2 and 3, FIGS. 2 and 3 illustrate an insulating layer 104. The insulating layer 104 may be used to reflect or direct heat or to prevent heat from exiting in an undesired direction. For example, it may be desirable to have all or most of the generated heat be directed towards a particular surface of the heating unit 100. In the embodiment illustrated in FIGS. 1 and 6A-6C, for example, it may be desirable to direct heat towards the one or more bags of asphalt patch 10 while directing heat away from an exterior environment in which the one or more bags of asphalt patch 10 are located. In the example illustrated, it may be desirable to have heat directed towards the side of the heating unit 100 which includes the second cover while directing heat away from the side that includes the first cover layer 102. The insulating layer 104 may be used to accomplish this task. Some exemplary embodiments of the heating unit have been implemented where about 95% of heat generated is directed towards a desired surface of the heating unit.

The insulating layer 104 may include a sheet of polystyrene, cotton batting, GORE-TEX®, fiberglass, foam rubber, etc. In certain embodiments, the insulating layer 104 may allow a portion of the heat generated by the heat generating element 114 to escape the through of the second cover layer 108 if desired. For example, the insulating layer 104 may include a plurality of vents to transfer heat to the second cover layer 108. In certain embodiments, the insulating layer 104 may be integrated with either the first cover layer 102 or the second cover layer 108. For example, the first cover layer 102 may include an insulation fill or batting positioned between two films of nylon.

In some embodiments, first and second cover layers 102 and 108 may comprise a textile fabric. The textile fabric may include natural or synthetic products. For example, the first and second cover layers 102 and 108 may comprise burlap, canvas, cotton or other materials. In another example, first and second cover layers 102 and 108 may comprise nylon, vinyl, or other synthetic textile material. The first and second cover layers 102 and 108 may comprise a thin sheet of plastic, metal foil, polystyrene, or other materials.

In manufacturing the heating unit 100, the heating element 106 and insulation layer 104 may be sealed between the first and second cover layers 102 and 108. As illustrated in FIGS. 2 and 3, the first and second cover layers 102 and 108 extend slightly beyond the heating element 106 and insulation layer 104. This allows the first and second cover layers 102 and 108 to be sealed, such as by using an adhesive, heat welding, or other appropriate method or combination of methods.

Additionally, the heating unit 100 may be constructed such that the first and second cover layers 102 and 108 may include one or more fasteners 124 for securing or connecting the heating unit 100. In some embodiments, the fasteners 124 may be attached or formed in the edges of the heating unit 100. In some embodiments, the fasteners 124 are one or more zippers that can be used to close the heating unit 100 around an object or material. In other embodiments, fastener 124 can be a hook and loop fastener such as VELCRO®. For example, the heating unit 100 may include a hook fabric on one side and a loop fabric on an opposite side. In other alternative embodiments, the fastener 124 may include grommets, snaps, adhesives, or other fasteners. Further, additional objects may be used with the fasteners to accomplish fastening. For example, when grommets are used, elastic cord, such as fixed or adjustable bungee cord may be used to connect to grommets on opposite sides of the heating unit 100. This may be used, for example, to securely wrap the heating unit around an object, such as one or more bags of asphalt patch.

A number of fastener arrangements may be implemented for securing the opposing sides of the heating unit together. For example, FIGS. 1 and 6A-6C illustrate the edges of the heating unit 100 as having zippers attached thereto. The zippers can be closed to substantially enclose one or more bags of asphalt patch 10 within heating unit 100.

Fasteners 124 can be adapted to enable selective coupling and decoupling to allow heating unit 100 to be selectively opened and closed. Alternatively, fasteners 124 can be adapted to permanently close at least a portion of heating unit 100. For example, grommet fasteners 124 can be secured to opposing portions of heating unit 100, where a single grommet may be secured to both opposing portions such that the heating unit permanently maintains a substantially enveloped shape.

In certain embodiments, the heating unit 100 may include one or more creases 128 to facilitate folding of the heating unit 100. The creases 128 may be oriented across the width or length of the heating unit 100. In some embodiments, a crease may be formed by heat welding a first cover layer 102 to a second cover layer 108. In some embodiments, the heating unit 100 comprises pliable material, however the creases 128 may facilitate folding a plurality of layers of the thermal heating unit 100.

In some embodiments, the first cover layer 102 may be positioned at the top of the heating unit 100 and the second cover layer 108 may be positioned on the bottom of the heating unit 100. In certain embodiments, the first cover layer 102 and the second cover layer 108 may comprise the same or similar material. Alternatively, the first cover layer 102 and the second cover layer 108 may comprise different materials, each material possessing properties beneficial to the specified surface environment.

For example, the first cover layer 102 may comprise a material that is resistant to sun rot such as polyester, plastic, and the like. The second cover layer 108 may comprise material that is resistant to mildew, mold, and water rot such as nylon. The cover layers 102 and 108 may comprise a highly durable material. The material may be textile or sheet, and natural or synthetic. For example, the cover layers 102 and 108 may comprise a nylon textile. Additionally, the cover layers 102 and 108 may be coated with a water resistant or waterproofing coating. For example, a polyurethane coating may be applied to the outer surfaces of the cover layers 102 and 108. Additionally, the top and bottom cover layers 102 and 108 may be colored, or coated with a colored coating such as paint. In some embodiments, the color may be selected based on heat reflective or heat absorptive properties. For example, the top layer 102 may be colored black for maximum solar heat absorption. The bottom layer 102 may be colored grey for a high heat transfer rate or to maximize heat retention beneath the cover.

Heating unit 100 can be folded and secured around the one or more containers, such as bags of asphalt patch, as illustrated in FIGS. 6A-6C. Specifically, as illustrated in FIG. 6A, with heating unit 100 laid open, the bags of asphalt patch 10 can be positioned generally on one side of the heating unit. With the bags of asphalt patch so positioned, the heating unit 100 can be folded over the bags of asphalt patch as shown in FIG. 6B. As noted herein, each of the components of heating unit 100 is pliable, thus enabling heating unit 100 to be folded over or wrapped around the bags of asphalt patch 10.

With the heating unit 100 folded over the bags of asphalt patch 10, the fasteners 124 can then be used to securely enclose the bags of asphalt patch 10 within the heating unit 100. For example, in FIG. 6C, fasteners 124 comprise zippers that are attached along the edges of heating unit 100. When the heating unit 100 has been folded over the bags of asphalt patch, the zippers can be closed to substantially enclose the bags of asphalt patch 10 within the heating unit 100.

The embodiment shown in the Figures include a nine (9) foot power cord 132 connected to the heat generating element 114. Other cord lengths may also be implemented within the scope of embodiments of the invention. The power cord may additionally be connected to an incoming direct current electrical connector 110 such as a bare wire connector, alligator clip connectors, a cigarette lighter plug connector, trailer hitch connector, or other appropriate connector for connecting the power cord to a direct current source of power, such as an automobile power source. Notably, modem wiring for trailer hitch wiring includes a six or seven pin connector which includes a power and ground terminal. Thus, some embodiments may include a six or seven pin mating connector to connect to the connector at the trailer hitch. Only the power and ground connectors of the mating connector need to be connected to the heat generating element 114. This allows, for example, for a heating unit to be used for heating items in the back of a truck bed.

Note that embodiments can be wired directly to the 12 volt source and turned on and off with a switch, can be hooked up to turn on and off with the start of the key, or can be simply connected in an always on so long as connected to power configuration. Additionally, some embodiments may include timing circuitry such that the heating unit 100 turns on or off for predetermined intervals, after the expiration of a predetermined time, etc.

Notably, some embodiments may be implemented with interchangeable incoming direct current electrical connectors. For example, the embodiment illustrated in FIG. 2 includes a kit which includes a heating unit 100 with a two pin auto connector 142. The kit may further include a wire 144 without an additional connector connected to a mating two pin auto connector 146, a set of alligator clips 148 connected to a mating two pin auto connector 150, and a cigarette lighter plug 110 connected to a mating two pin auto connector 152. A user can then select an appropriate incoming direct current electrical connection 110. For example, a user may select the wire 144 without additional connector if the heating unit 100 is to be hard wired to an electrical system, such as an automobile, boat, or other electrical system. Cigarette lighter plugs 110 or alligator clip 148 connections could be selected for more temporary connections.

Additionally, some embodiments may include an outgoing direct current electrical connection 112. This may be used, for example to allow chaining of heating units together. In the example illustrated, the outgoing direct current electrical connection 112 is connected electrically to the incoming direct current electrical connection through conductors 126 passing through the heating unit 100. Other embodiments may allow the incoming electrical connection 110 and outgoing electrical connection 112 to be more or less proximate to each other as appropriate. Note that many embodiments do not include outgoing direct current electrical connections due to the high amperage that may pass through conductors when multiple units are chained together. As noted above, high current may be controlled through various current control devices such as circuit breakers and current limiting elements.

While not illustrated in the Figures, some embodiments may include, in addition to the DC connections illustrated above, an AC plug. The AC plug may be connected to an additional heat generating element that is configured to operate at the higher voltages typically found in AC circuit, such as 120 or 240 V circuits. To maintain consistency of heating, the heat generating element may nonetheless be configured to output a similar wattage of heat per lineal measurement as the heat generating element 114. For example, the heat generating element connected to the AC plug may be configured to deliver 9 Watts per linear foot. Some embodiments may further include an AC receptacle to allow for daisy chaining of heating units where the electrical conductors of the AC receptacle are electrically connected to electrical conductors of the AC plug.

Notably, embodiments that include both a DC plug and an AC plug may further include various switches configured to select which power source will be in use at a given time. Such switches may be, for example, manual toggle switches. Alternatively or additionally, such switches may be mechanical or solid state switches or relays which include functionality for detecting current being applied to the AC or DC plug and selecting an appropriate heat generating element based on the detection

Some embodiments may further include timing circuitry such that a user can select when heating should occur. The timer may be an electronic controlled device supplied by the electrical connector 112 and may include internal switching such as relays or solid state switches for supplying power to the heat generating strip 114.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A portable pouch for warming materials, the pouch comprising:
a heating unit having one or more fasteners attached around its outer edges, the heating unit being adapted to be folded to enable the one or more fasteners to secure together opposing outer edges of the heating unit to form a pocket for substantially enclosing the materials to be warmed, the heating unit being adapted for electrical connection to a direct current power source, the heating unit comprising:
first and second cover layers;
an electrical heating element disposed between the first and the second cover layers and configured to convert electrical energy from the direct current source to heat energy and to distribute the heat energy over a surface of said heating unit, the electrical heating element comprising:
a heat generating element for converting electrical current to heat energy; and
a carbon-based heat spreading element thermally coupled to the heat generating element for evenly distributing the heat energy over the surface of the heating unit; and
a thermal insulation layer positioned adjacent the electrical heating element and between the first and the second cover layers.

2. The portable pouch of claim 1, wherein the pocket formed by the heating unit is sized to receive one or more bags of asphalt patch.

3. The portable pouch of claim 1, wherein the heat spreading element comprises graphite.

4. The portable pouch of claim 1, further comprising a receiving power connector electrically connected to the heat generating element, the receiving power connector configured to couple to the direct current power source.

5. The portable pouch of claim 4, wherein the direct current power source is an automotive power source.

6. The portable pouch of claim 4, wherein the receiving power connector is an automotive power connector, a cigarette lighter connector, alligator clips, or a mating trailer hitch connector.

7. The portable pouch of claim 1, wherein the heat spreading element is attached to the heat generating element with an adhesive.

8. The portable pouch of claim 1, wherein the thermal insulation layer is attached to the electrical heating element with an adhesive.

9. The portable pouch of claim 1, wherein the one or more fasteners comprise zippers, grommets, snaps, or a combination thereof.

10. The portable pouch of claim 1, wherein the heating unit comprises a thermostat configured to regulate an operating temperature of the heating unit.

11. The portable pouch of claim 10, wherein the thermostat is set at a predetermined temperature.

12. The portable pouch of claim 10, wherein the thermostat is user adjustable.

13. A method of heating a temperature sensitive material during transportation of the material, the method comprising:
folding a heat generating element around a temperature sensitive material;
folding a graphite heat spreading element around the temperature sensitive material and the heat generating element;
folding a thermal insulation layer around the heat generating element, the heat spreading element, and the temperature sensitive material;
securing opposing edges of the thermal insulation layer and the heat spreading element around the temperature sensitive material;
applying a direct current electrical source to the heat generating element causing the heat generating element to create heat; and
spreading the heat generated by the heat generating element in a substantially uniform fashion with the heat spreading element.

14. The method of claim 13, wherein applying a direct current electrical source to the heat generating element comprises connecting the heat generating element to an electrical system of an automobile.

15. The method of claim 14, wherein connecting the heat generating element to an electrical system of an automobile comprises connecting the heat generating element to the electrical system of the automobile using hard wiring, alligator clips, or a cigarette lighter plug.

16. The method of claim 13, further comprising thermally and electrically connecting to the heat generating element a thermostat configured to regulate an operating temperature of the heat generating element.

17. The method of claim 16, further comprising manually setting the thermostat to a predetermined temperature.

18. A direct current heating unit for warming temperature sensitive materials during transportation of the materials, the heating unit comprising:
an electrical heating element adapted to convert electrical energy to heat energy and to distribute the heat energy over a surface of said heating unit, the electrical heating element comprising:
a heat generating element for converting electrical current to heat energy, the heat generating element being adapted for electrical connection to a direct current power source; and
a heat spreading element comprising graphite, the heat spreading element thermally coupled to the heat generating element for evenly distributing the heat energy over the surface of said heating unit;
a thermal insulation layer positioned adjacent a first side of the electrical heating element, the thermal insulation layer being adapted to direct heat toward a second side of the electrical heating element; and
a cover adapted to substantially enclose the electrical heating element and the thermal insulation layer, the cover having one or more fasteners disposed about outer edges of the cover,
wherein the heating unit is adapted to be folded to enable the one or more fasteners to secure together opposing outer edges of the heating unit, thereby forming a pocket for substantially enclosing the materials to be warmed.

19. The direct current heating unit of claim 18, wherein the one or more fasteners comprise one or more zippers.

20. The direct current heating unit of claim 19, wherein the heat generating element is electrically connected to a direct current automotive power source by way of a cigarette lighter connector, alligator clips, or a mating trailer hitch connector.
